(19) United States
(12) Patent Application Publication
(10) Pub. No.: US 2024/0412753 A1
(43) Pub. Date: Dec. 12, 2024

(54) VOICE ACTIVITY DETECTION DEVICE AND VOICE ACTIVITY DETECTION METHOD

(71) Applicant: SigmaStar Technology Ltd., Xiamen (CN)

(72) Inventor: Xiao-Ding ZHU, Shanghai (CN)

(21) Appl. No.: 18/650,279

(22) Filed: Apr. 30, 2024

(30) Foreign Application Priority Data
Jun. 8, 2023 (CN) 202310678003.X

(51) Int. Cl. G10L 25/78; G10L 15/08

(52) U.S. Cl. CPC G10L 25/78; G10L 15/08; G10L 2015/088

(57) ABSTRACT

A voice activity detection device includes an audio processing circuit, a first memory, and a processor. The audio processing circuit processes an audio signal from an audio generator circuit to generate first audio data. The first memory stores the first audio data and a first program code. The processor executes the first program code to operate in a first mode, and is switched from operating in the first mode to operating in a second mode in response to an interrupt signal from the audio generator circuit, in order to determine whether the first audio data stored in the first memory includes a human voice signal, wherein power consumption of the processor operating in the first mode is lower than that in the second mode.

This application claims the benefit of China application Serial No. 202310678003.X, filed on Jun. 8, 2023, the subject matter of which is incorporated herein by reference.

### BACKGROUND OF THE INVENTION

### Field of the Invention

The present application relates to a voice activity detection device, and more particularly, to a voice activity detection device and a voice activity detection method capable of reducing power consumption.

### Description of the Related Art

Voice controlled electronic devices have become more diversified along with technology development. In the prior art, a voice activity detection device usually uses a master processor and a slave processor to detect a voice instruction. During standby, the master processor is in a sleep state, and the slave processor remains operable so as to wait for an instruction and accordingly wake up the master processor. Once having woken the master processor, the slave processor enters a sleep mode, and the woken master processor then performs subsequent operations according to the voice instruction. In the technique above, the master processor and the slave processor commonly access the same memory, such that the memory is unable to actively switch to operating in a low-power mode. Moreover, within the same period, either of the master processor and the slave process that is in a sleep state does not perform other substantial operations, leading to increased system costs and power consumption.

### SUMMARY OF THE INVENTION

In some embodiments, it is an object of the present application to provide a voice activity detection device and a voice activity detection method capable of reducing power consumption, so as to solve the issues of the prior art.

In some embodiments, the voice activity detection device includes an audio processing circuit, a first memory, and a processor. The audio processing circuit processes an audio signal from an audio generator circuit to generate first audio data. The first memory stores the first audio data and a first program code. The processor executes the first program code to operate in a first mode, and is switched from operating in the first mode to operating in a second mode in response to an interrupt signal from the audio generator circuit, in order to determine whether the first audio data stored in the first memory includes a human voice signal, wherein power consumption of the processor operating in the first mode is lower than that in the second mode.

In some embodiments, the voice activity detection method includes operations of: generating first audio data according to an audio signal from an audio generator circuit, and storing the first audio data to a first memory; controlling a processor to execute a first program code in the first memory and to operate in a first mode; and switching to operating in a second mode by the processor in response to an interrupt signal from the audio generator circuit so as to execute a second program code in the memory, in order to determine whether the first audio data stored in the first memory includes a human voice signal, wherein power consumption of the processor operating in the first mode is lower than that in the second mode.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of a voice activity detection device according to some embodiments of the present application;

FIG. 2 is a flowchart of operations of the voice activity detection device in FIG. 1 according to some embodiments of the present application;

FIG. 3 is a schematic diagram of operations of multiple memories in FIG. 1 according to some embodiments of the present application;

FIG. 4 is a flowchart of operations of the voice activity detection device in FIG. 1 according to some embodiments of the present application;

FIG. 5 is a waveform timing diagram of a signal in FIG. 1 according to some embodiments of the present application; and

FIG. 6 is a flowchart of a voice activity detection method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

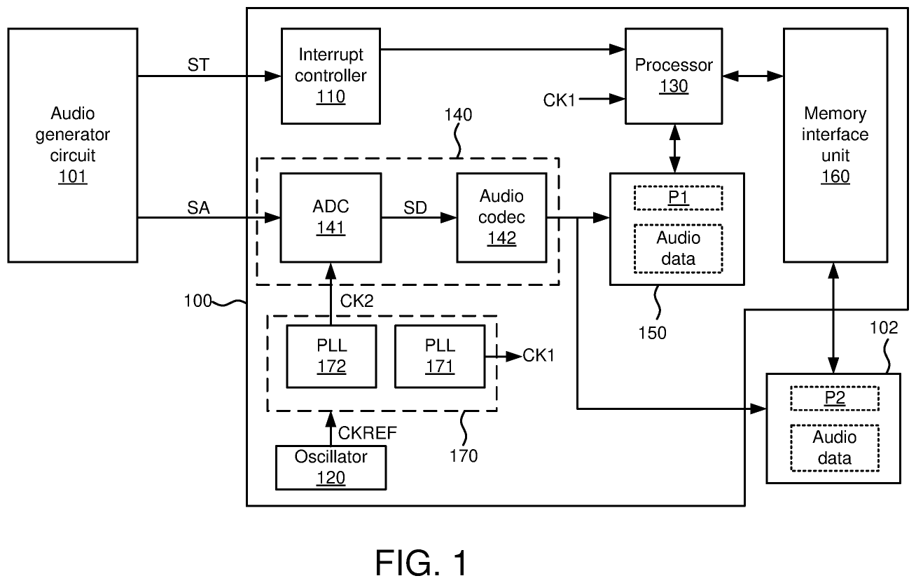

FIG. 1 shows a schematic diagram of a voice activity detection (VAD) device 100 according to some embodiments of the present application. The voice activity detection device 100 includes an interrupt controller 110, an oscillator 120, a processor 130, an audio processing circuit 140, a memory 150, a memory interface unit 160 and a clock generator circuit 170. The interrupt controller 110 is coupled to the audio generator circuit 101, receives an interrupt signal ST generated by the interrupt generation circuit 101, and performs corresponding hardware/software processing in response to the interrupt signal ST. In some embodiments, the audio generator circuit 101 may collect audio signals in an application environment and generate an audio signal SA. The audio generator circuit 101 may provide the audio signal SA to the audio processing circuit 140, and determine whether the audio signal SA satisfies a predetermined condition so as to generate the interrupt signal ST. For example, when the audio generator circuit 101 determines that a volume of the audio signal SA exceeds a predetermined threshold, the audio generator circuit 101 may generate the interrupt signal ST.

The oscillator 120 may generate a reference clock signal CKREF and transmit the reference clock signal CKREF to the clock generator circuit 170. In some embodiments, the oscillator 120 may be, for example but not limited to, a quartz oscillator. The clock generator circuit 170 may generate clocks needed in the processor 130, the audio processing circuit 140 and other circuits in the system according to the reference clock signal CKREF. For example, the clock generator circuit 170 may include a phase-locked loop (PLL) 171 and a PLL 172. The PLL 171 may generate a clock signal CK1 according to the reference clock signal CKREF, and provide the clock signal CK1 to the processor 130. Similarly, the PLL 172 may generate a clock signal CK2 according to the reference clock signal CKREF, and provide the clock signal CK2 to the audio processing circuit 140.

The processor 130 may access a program code P1 stored in the memory 150, so as to operate in a first mode and wait for the audio generator circuit 101 to generate the interrupt signal ST. When the audio generator circuit 101 generates the interrupt signal ST, the processor 130 may switch to executing a program code P2 in the memory 101 in response to the interrupt signal ST, so as to switch from operating in the first mode to operating in a second mode, thereby determining whether one or more audio data stored in the memory 150 includes a human voice signal. In some embodiments, power consumption generated by the processor 130 operating in the first mode is lower than power consumption of the processor 130 operating in the second mode. In other words, the first mode may be a low-power mode (or referred to as a wait-for-interrupt) mode. When the processor 130 operates in the first mode, the processor 130 operates at a lower operating speed and waits to receive the interrupt signal ST, thereby reducing power consumption. Alternatively, when the processor 130 switches to operating in the second mode, the processor 130 switches to receiving the clock signal CK1 having a higher frequency and thus operates at a high operating speed, so as to more quickly detect whether there is a voice control instruction to be processed.

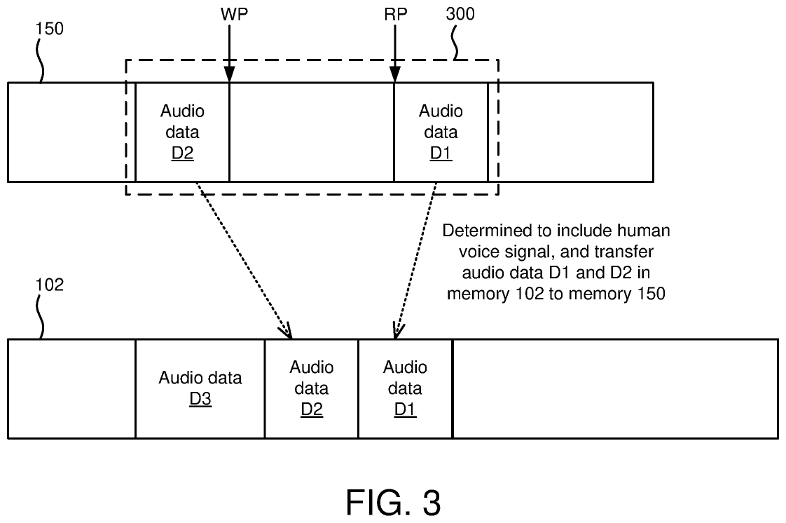

In some embodiments, the memory 150 may be, for example but not limited to, a static random access memory (SRAM). The processor 130 may be coupled to the memory 102 via the memory interface unit 160. In some embodiments, the memory 102 may be, for example but not limited to, a dynamic random access memory (DRAM). The audio processing circuit 140 may process the audio signal SA to generate audio data (for example, audio data D1 to D3 in FIG. 3). For example, the audio processing circuit 140 may include an analog-to-digital converter (ADC) 141 and an audio coder-decoder (codec) 142. The ADC 141 converts the audio signal SA according to the clock signal CK2 to generate digital data SD. The audio codec 142 processes the digital data SD to generate the audio data.

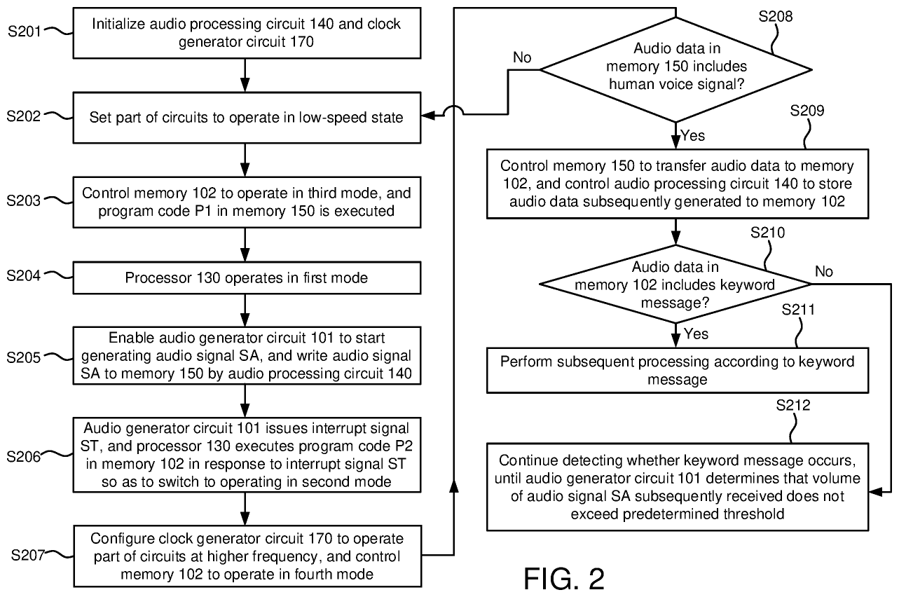

FIG. 2 shows a flowchart of operations of the voice activity detection device 100 in FIG. 1 according to some embodiments of the present application. In some embodiments, multiple operations in FIG. 2 correspond to a loop mode. In operation S201, the audio processing circuit 140 and the clock generator circuit 170 are initialized. For example, after startup of the voice activity detection device 100, the processor 130 may execute system-related software and/or firmware, so as to perform initial settings of various parameters (for example but not limited to, clock frequency, sampling rate, gain value and encoding/coding format) in the audio processing circuit 140 and the clock generator circuit 170. In operation S202, part of the circuits (excluding the PLL 172) are set to operate in a low-speed state. For example, once the initialization is complete, the related software and/firmware may further turn off the PLL 171, and switch the clock signal received by the processor 130 from the clock signal CK1 to another clock signal (not shown in FIG. 2, having a frequency lower than a frequency of the reference clock signal CKREF, for example) generated based on the reference clock signal CKREF. Meanwhile, the related software and/or firmware may further switch a clock signal (not shown) received by the memory interface unit 160 to the reference clock signal CKREF, so that the memory interface unit 160 also operates in the low-speed state. On the other hand, since the PLL 172 is not turned off, the PLL 172 is able to provide the clock signal CK2 to the audio processing circuit 140 according to the reference clock signal CKREF.

In operation S203, the memory 102 is controlled to operate in a third mode, and the program code P1 in the memory 150 is executed by the processor 130. In operation S204, the processor 130 operates in the first mode. For example, as described above, the processor 130 may execute the program code P1 stored in the memory 150, so as to operate in the first mode and wait for the audio generator circuit 101 to generate the interrupt signal ST. On the other hand, the related software and/firmware may control the memory 102 to operate in the third mode. In some embodiments, the third mode may be a low-power mode of the memory 102. For example, if the memory 102 is a DRAM, the third mode may be s self-refresh mode. When the processor 130 executes the program code P1 in the memory 150 and operates in the first mode, the processor 130 does not access the memory 102 or has less requirements of accessing the memory 102. In this case, the operating speeds of a part of the circuits (for example, including the memory 102 and the memory interface unit 160) can be decreased so as to reduce the overall power consumption.

In operation S205, the audio generator circuit 101 is enabled to start generating the audio signal SA, and the audio data is written to the memory 150 by the audio processing circuit 140. As described above, when the processor 130 executes the program code P1 in the memory 150, the processor 130 operates in the first mode and waits for the audio generator circuit 101 to generate the interrupt signal ST. Once the audio generator circuit 101 is enabled by the related software and/or firmware, the audio generator circuit 101 may start collecting sounds in the environment so as to generate the audio signal SA, and store the audio data corresponding to the audio signal SA to the memory 150 by the audio processing circuit 150.

In operation S206, the audio generator circuit 101 issues the interrupt signal ST, and the processor 130 executes the program code P2 in the memory 102 in response to the interrupt signal ST so as to switch to operating in the second mode. In operation S207, the clock generator circuit 170 is configured to switch the part of the circuits to operating at a higher frequency, and control the memory 102 to operate in a fourth mode. For example, when the audio generator circuit 101 determines that the volume of the audio signal SA exceeds the predetermined threshold, the audio generator circuit 101 may issue the interrupt signal to the interrupt controller 110, such that the processor 130 may switch to executing the program code P2 in the memory 102 in response to the interrupt signal ST so as to operate in the second mode. On the other hand, in this case, the software and/or firmware may correspondingly configure the clock generator circuit 170, so that the PLLs 171 and 172 may generate the clock signal CK1 and the clock signal CK2 having higher frequencies, and the memory interface unit 160 switches 160 to operating based on a clock signal having a higher frequency. Meanwhile, the related software and/firmware may control the memory 102 to switch to operating in the fourth mode, which may be an active mode operating at a faster speed. In other words, the power consumption generated by the memory 102 operating in the third mode is lower than the power consumption generated by the memory 102 operating in the fourth mode.

In operation S208, it is determined whether the audio data in the memory 150 includes a human voice signal. Operation S209 is performed if it is determined that the audio signal in the memory 150 includes the human voice signal. Alternatively, operation S202 is performed if it is determined that the audio signal in the memory 150 does not include the human voice signal. In operation S209, the memory 150 is controlled to transfer the audio data to the memory 102, and the audio processing circuit 140 is controlled to store audio data subsequently generated to the memory 102. For example, the program code P2 in the memory 102 includes a signal processing algorithm for recognizing human voice signals. The processor 130 may execute the program code P2 to determine according to the algorithm whether the audio data in the memory 150 includes the human voice signal. If the audio data includes the human voice signal, the processor 130 may control the memory 150 to transfer the audio data to the memory 102 (instead of storing the audio data to the memory 150). Thus, once the audio data is transferred to the memory 102, the processor 130 may release a temporary storage space previously storing the audio data in the memory 150 for use of other circuits in the system. If the audio data does not include the human voice signal, operation S202 is repeated so as to wait for a next voice instruction.

In operation S210, it is determined whether the audio data in the memory 102 includes a keyword message. Operation S211 is performed if it is determined that the audio signal in the memory 102 includes the keyword message. Operation S212 is performed if it is determined that the audio signal in the memory 102 does not include the keyword message. In operation S211, subsequent processing is performed according to the keyword message. In operation S212, it is continually detected whether the keyword message occurs, until the audio generator circuit 101 determines that the volume of the audio signal SA subsequently received does not exceed the predetermined threshold.

For example, the program code P2 in the memory 102 further includes a signal processing algorithm for recognizing keyword messages. The processor 130 may execute the program code P2 to determine according to the algorithm whether the audio data in the memory 102 includes the keyword message. In some embodiments, the keyword message may be, for example but not limited to, a voice instruction for controlling a predetermined device to perform a predetermined operation. If the processor 130 determines that the audio data in the memory 102 includes the keyword message, the processor 130 may perform subsequent processing according to the keyword message, so as to control the predetermined device to perform the predetermined operation. Alternatively, if the processor 130 determines that the audio data in the memory 102 does not include the keyword message, the processor 130 may continue determining according to the audio data subsequently stored in the memory 102 whether the keyword message occurs, until the audio generator circuit 101 determines that the volume of the audio signal SA subsequently received does not exceed the predetermined threshold (for example, when a user stops inputting the voice instruction).

In the operations above, the processor 130 executes the program code P1 in the memory 150 so as to operate in the first mode to reduce the power consumption and wait for the interrupt signal ST. Thus, the operation of the processor 130 operating in the first mode is relatively simple. The processor 130 executes the program code P2 in the memory 102 to operate in the second mode, so as to execute the multiple algorithms for voice recognition and keyword recognition at a higher speed. Thus, both a code size and/or complexity of the program code P1 are less than a code size and/or complexity of the second program code P2. In some embodiments, since a cost of the memory 1050 is higher than that of the memory 102, the configuration above is capable of reducing a volume required by the memory 150, hence further reducing an overall cost. Moreover, after switching to using the second memory 102, the memory 150 may release a temporary storage space previously storing the audio data, and so other circuits in the system may also commonly use the memory 150 in a time-division manner, thereby preventing a requirement of providing an addition memory and reducing additional power consumption of the system and/or system costs.

FIG. 3 shows a schematic diagram of operations of the memory 150 and the memory 102 in FIG. 1 according to some embodiments of the present application. As described above, the memory 150 may be an SRAM. The processor 130 may configure the memory 150 so as to plan a temporary storage space, which may be set as a ring buffer 300. The processor 130 may access the ring buffer 300 according to a write indicator WP and a read indicator RP. Before operation S209 is performed, the audio data D1 and the audio data D2 generated by the audio processing circuit 140 according to the audio signal SA of the audio generator circuit 101 may be stored in the ring buffer 300. In operation S209, the processor 130 reads the audio data D1 according to the read indicator RP and determines that the audio data D1 includes the human voice signal, and thus transfers the audio data D1 and the audio data D2 (the write indicator WP corresponds to an ending position of the audio data D2, indicating that the audio data D2 is also valid audio data) to the memory 102, and controls the audio processing circuit 140 to store the audio data D3 subsequently generated to the memory 102. That is, the audio processing circuit 140 generates the audio data D3 according to the audio signal SA after generating the multiple audio data D1 and D2. Once the audio data D1 and the audio data D2 are transferred to the memory 102, the corresponding temporary storage space in the ring buffer 300 may be released. Next, the processor 130 may determine according to the multiple consecutive audio data D1, D2 and D3 in the memory 102 whether the human voice signal and the keyword message are included. Thus, the processor 130 may combine the multiple audio data D1, D2 and D3, and more comprehensively determine according to the consecutive audio contents of the combined audio data whether the user has issued a voice instruction.

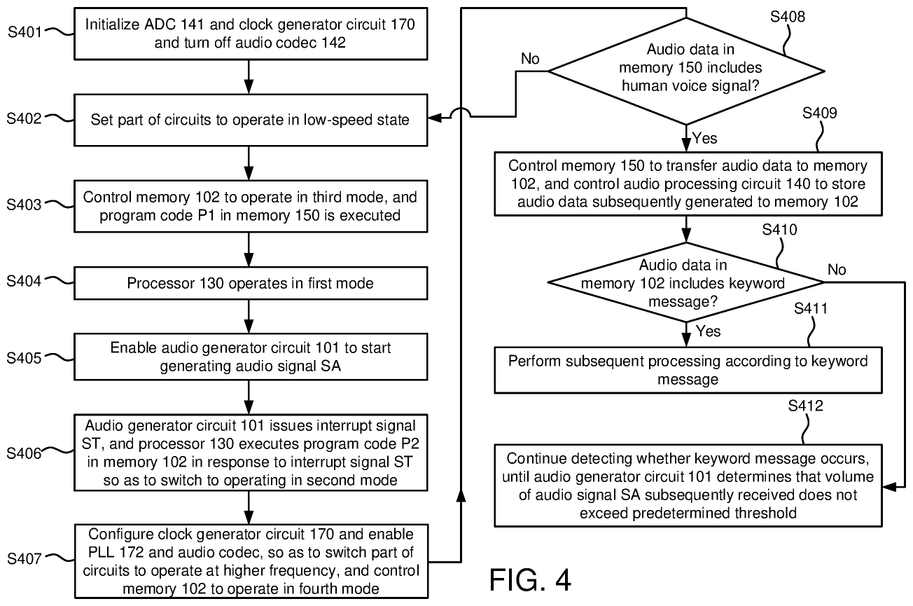

FIG. 4 shows a flowchart of operations of the voice activity detection device 100 in FIG. 1 according to some embodiments of the present application. In some embodiments, the multiple operations in FIG. 4 correspond to an interrupt mode, of which power consumption may be lower than power consumption of the loop mode in FIG. 2. The interrupt mode includes multiple operations S401 to S412, wherein the multiple operations S403, S404, S406 and S408 to S412 are respectively the same as the multiple operations S203, S204, S206 and S208 to S212, and such repeated details are omitted herein. Differences from the operations in FIG. 2 are primarily described below.

In operation S401, the ADC 141 and the clock generator circuit 170 are initialized, and the audio codec 142 is turned off. Different from operation S201, in this example, shortly after the voice activity detection device 100 is started, the processor 130 may execute system-related software and/or firmware, and only perform initialization settings of the ADC 141 and the clock generator 142, wherein the audio codec 142 remains in the off state. In operation S402, part of the circuits (including the PLL 171 and the PLL 172) are set to operate in a low-speed state. Different from operation S202, in this example, the related software and/or firmware further turns off the PLL 172. In this case, the clock generator circuit 170 does not provide the clock signal CK2 to the audio processing circuit 140.

In operation S405, the audio generator circuit 101 is enabled so as to start generating the audio signal SA. Different from operation S205, in this example, since the audio processing circuit 140 does not receive the clock signal CK2 and the audio codec 142 is not yet enabled, the audio processing circuit 140 at this point does not generate any corresponding audio data according to the audio signal SA, and does not store the corresponding audio data to the memory 150.

In operation S407, the clock generator circuit 170 is configured, and the PLL 172 and the audio codec 142 are enabled, so that the part of the circuits switch to operating at a higher frequency, and the memory 102 is controlled to operate in the fourth mode. Different from FIG. 2, in this example, when the audio generation circuit 101 determines that the volume of the audio signal SA exceeds the predetermined threshold, the related software and/or firmware may configure the clock generator circuit 170 and enable all PLLs (for example, including the PLL 171 and the PLL 172) and the audio codec 142, so as to start generating the clock signal CK1 and the clock signal CK2 having higher frequencies. Thus, the clock generator circuit 170 starts providing the clock signal CK2 to the ADC 141, such that the audio codec 142 may start generating the corresponding audio data and start storing the audio data to the memory 150. On the other hand, the processor 130 may execute the program code P2 in the memory 102 in order to determine whether the audio data in the memory 150 includes the human voice signal.

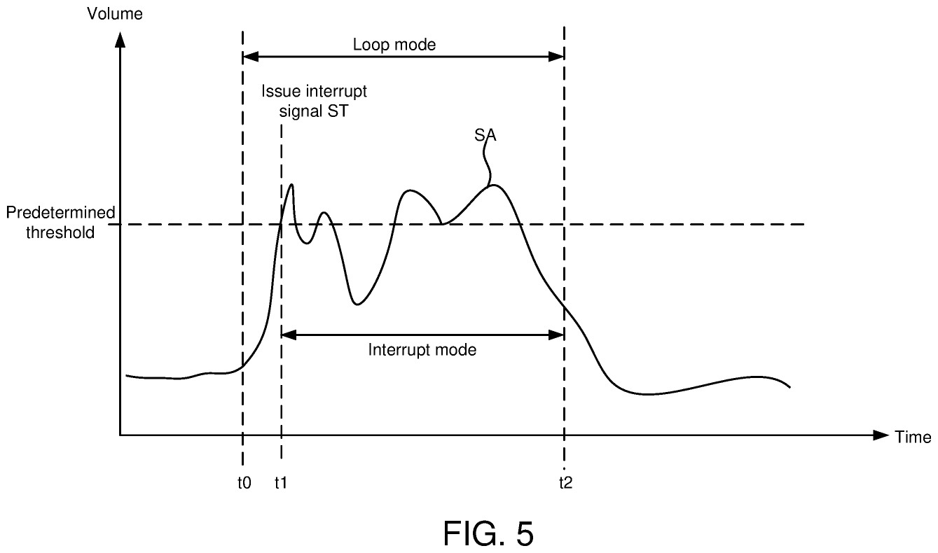

Accordingly, it can be understood that, in the loop mode in FIG. 2, the audio processing circuit 140 stores the audio data to the memory 150 when the processor 130 operates in the first mode. Different from FIG. 2, in the interrupt mode in FIG. 4, the clock generator circuit 170 does not generate the clock signal CK2 when the processor 130 operates in the first mode, such that at least a part of the circuits in the audio processing circuit 140 are in a disabled state and are inoperable, so that no audio data is generated to the memory 150. Once the interrupt signal ST is received, the processor 130 switches to operating in the second mode, and the audio processing circuit 140 starts generating and storing the audio data to the memory 150. Thus, the interrupt mode in FIG. 4 is capable of further reducing power consumption. In contrast, the loop mode in FIG. 2 is capable of collect more complete audio data. Associated details herein are to be described with reference to FIG. 5 below.

FIG. 5 shows a waveform timing diagram of the signal SA in FIG. 1 according to some embodiments of the present application. To better understand the differences between the loop mode in FIG. 2 and the interrupt mode in FIG. 4, as shown in FIG. 5, in the loop mode, the audio codec 142 and the PLL 172 are enabled, such that the audio processing circuit 140 may start storing the corresponding audio data to the memory 150 at a timing t0. When the audio generator circuit 101 determines that the volume of the audio signal SA is greater than the predetermined threshold, the audio generator circuit 101 issues the interrupt signal ST, so that the processor 130 may switch to operating in the second mode at a timing t1 and start determining whether the audio data include the human voice signal and the keyword message, until the volume of the audio data SA starts to become lower than the predetermined threshold at a timing t2. Different from the loop mode, in the interrupt mode, the audio processing circuit 140 does not yet start storing the corresponding audio data to the memory 150 at the timing to, but only starts storing the corresponding audio data to the memory 150 after receiving the interrupt signal ST at the timing t1. In other words, in the loop mode, the voice activity detection device 100 may store more complete audio data for detection, and therefore high voice activity detection accuracy can be achieved. In the interrupt mode, the power consumption generated by the audio processing circuit 140, the clock generator circuit 170 and the memory 150 before the timing t1 is lower, so that the voice activity detection device 100 operating in the interrupt mode can also achieve lower power consumption.

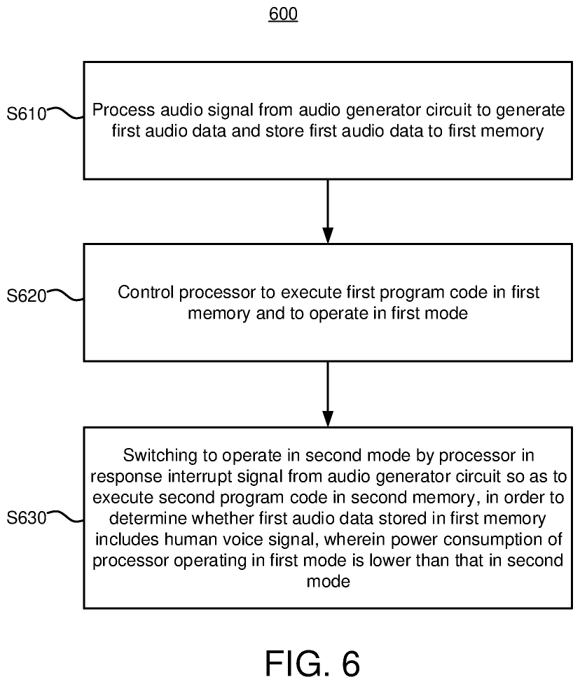

FIG. 6 shows a flowchart of a voice activity detection method 600 according to some embodiments of the present application. In operation S610, first audio data is generated from an audio signal from an audio generator circuit, and the first audio data is stored to a first memory. In operation S620, control a processor to execute a first program code in the first memory and to operate in a first mode. In operation S630, it is switched to operating in a second mode in response to an interrupt signal from the audio generator circuit so as to execute a second program code in a second memory, in order to determine whether the first audio data stored in the first memory includes a human voice signal, wherein power consumption of the processor operating in the first mode is lower than that in the second mode.

Details associated with the multiple operations of the voice activity detection method 600 above can be referred from the details of the embodiments above, and are omitted herein. The multiple operations in FIG. 2, FIG. 4 and/or FIG. 6 are merely examples, and are not limited to being performed in the order specified in the examples. Without departing from the operation means and ranges of the various embodiments of the present application, additions, replacements, substitutions or omissions may be made to the operations in FIG. 2, FIG. 4 and/or FIG. 6, or the operations may be performed in different orders (for example, entirely simultaneously performed or partially simultaneously performed).

In conclusion, the voice activity detection device and the voice activity detection method in some embodiments of the present application are capable of performing voice activity detection without involving an additional slave processor, as well as further improving power consumption.

While the present application has been described by way of example and in terms of the preferred embodiments, it is to be understood that the disclosure is not limited thereto. Various modifications made be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A voice activity detection device, comprising:
an audio processing circuit, processing an audio signal from an audio generator circuit to generate first audio data;
a first memory, storing the first audio data and a first program code; and
a processor, executing the first program code to operate in a first mode, and switched from operating in the first mode to operating in a second mode in response to an interrupt signal from the audio generator circuit, in order to determine whether the first audio data stored in the first memory includes a human voice signal,
wherein power consumption of the processor operating in the first mode is lower than that in the second mode.

2. The voice activity detection device according to claim 1, wherein when the processor determines that the first audio data includes the human voice signal, the processor further controls the first memory to transfer the first audio data to the second memory, and the audio processing circuit further stores second audio data to the second memory, wherein the audio processing circuit generates the second audio data according to the audio signal after generating the first audio data.

3. The voice activity detection device according to claim 2, wherein the processor further determines, according to the first audio data and the second audio data in the second memory, whether the first audio data and the second audio data include a keyword message.

4. The voice activity detection device according to claim 2, wherein after the first memory transfers the first audio data to the second memory, the first memory further releases a storage space previously storing the first audio data from the first memory.

5. The voice activity detection device according to claim 1, wherein the processor further controls the second memory from operating in a third mode to operating in a fourth mode in response to the interrupt signal, and power consumption of the second memory operating in the third mode is lower than that in the fourth mode.

6. The voice activity detection device according to claim 5, wherein the second memory is a dynamic random access memory (DRAM), the third mode is a self-refresh mode, and the fourth mode is an active mode.

7. The voice activity detection device according to claim 1, wherein when the processor operates in the first mode, the audio processing circuit stores the first audio data to the first memory.

8. The voice activity detection device according to claim 1, wherein when the processor operates in the first mode, the audio processing circuit does not store the first audio data to the first memory.

9. The voice activity detection device according to claim 1, wherein the audio processing circuit comprises:
an analog-to-digital converter (ADC), converting the audio signal into digital data; and
The audio encoder-decoder (codec), processing the digital data to generate the first audio data.

10. The voice activity detection device according to claim 1, further comprising:
a clock generator circuit, generating a first clock signal according to a reference clock signal,
wherein when the processor operates in the first mode, the clock generator circuit generates the first clock signal for the audio processing circuit, and the audio processing circuit processes the audio signal according to the first clock signal so as to generate the first audio data.

11. The voice activity detection device according to claim 1, further comprising:
a clock generator circuit, generating a first clock signal according to a reference clock signal,
wherein when the processor operates in the first mode, the clock generator circuit does not generate the first clock signal, such that the audio processing circuit does not generate the first audio data.

12. The voice activity detection device according to claim 1, wherein a code size of the first program code is smaller than a code size of the second program code.

13. A voice activity detection method, comprising:
generating first audio data according to an audio signal from an audio generator circuit, and storing the first audio data to a first memory;
controlling a processor to execute a first program code in the first memory and to operate in a first mode; and
switching to operating in a second mode by the processor in response to an interrupt signal from the audio generator circuit so as to execute a second program code in a second memory, in order to determine whether the first audio data stored in the first memory includes a human voice signal, wherein power consumption of the processor operating in the first mode is lower than that in the second mode.
